(19) United States
(12) Patent Application Publication
(10) Pub. No.: US 2004/0253982 A1
(43) Pub. Date: Dec. 16, 2004

(54) Dual mode wireless network card for supporting GPRS communication device and wireless receiver

(76) Inventor: Wen Huiang Wu, Tau Yuan Hsien (TW)

Correspondence Address: Wen Huiang Wu, 235 P.O. Box 10-69, Chung-Ho, Taipei, TW

(21) Appl. No.: 10/457,710

(22) Filed: Jun. 10, 2003

(51) Int. Cl. H04M 1/00

(52) U.S. Cl. 455/558; 455/552.1

(57) ABSTRACT

A dual mode wireless network card serves for supporting a GPRS communication device and a wireless receiver. The wireless network card is connected to a GPRS communication device and a wireless receiver. The GPRS communication device uses a PPP communication protocol for using in far-end data communication; the wireless receiver transmits data through a gateway for performing near-end data communication. The wireless network card includes a driving program for switching. When the GPRS communication device is turned off, the wireless network card is switched to the wireless receiver for near-end transmission. The wireless network card can be switched to the GPRS communication device so as to be used suburbs. When the user is indoors with the GPRS communication device being turned on. The wireless network card scans the wireless receiver; if there are signals of the wireless receiver, then the mode is switched for receiving signals of wireless receiver.

### FIELD OF THE INVENTION

The present invention relates to wire communications, and particular to a dual mode wireless network card for supporting a GPRS communication device and a wireless receiver.

### BACKGROUND OF THE INVENTION

With the improvement of wireless network, the technology of network has cause the wireless equipment provider to understand the importance of the requirement of convenience. In fact, in the prior art, the transmission device has only one protocol used in wireless network or wired network. Thereby, the application is confined.

### SUMMARY OF THE INVENTION

Accordingly, the primary object of the present invention is to provide a dual mode wireless network card for supporting a GPRS communication device and a wireless receiver. The wireless network card is connected to a GPRS communication device and a wireless receiver. The GPRS communication device uses a PPP communication protocol for using in far-end data communication; the wireless receiver transmits data through a gateway for performing near-end data communication. The wireless network card includes a driving program for switching. When the GPRS communication device 2 is turned off, the wireless network card is switched to the wireless receiver for near-end transmission. The wireless network card can be switched to the GPRS communication device so as to be used suburbs. When the user is indoors with the GPRS communication device being turned on, the wireless network card scans the wireless receiver. If there are signals of the wireless receiver, then the mode is switched for receiving signals of wireless receiver.

The various objects and advantages of the present invention will be more readily understood from the following detailed description when read in conjunction with the appended drawing.

### BRIEF DESCRIPTION OF THE DRAWINGS

FIG. 1 is a schematic view for the structure of the wireless network card of the present invention.

FIG. 2 is a block diagram of the present invention.

FIG. 3 shows the internal structure of the wireless network card of the present invention.

### DETAILED DESCRIPTION OF THE INVENTION

In order that those skilled in the art can further understand the present invention, a detail description will be described in the following. However, these descriptions and the appended drawings are only used to cause those skilled in the art to understand the objects, features, and characteristics of the present invention, but not to be used to confine the scope and spirit of the present invention defined in the appended claims.

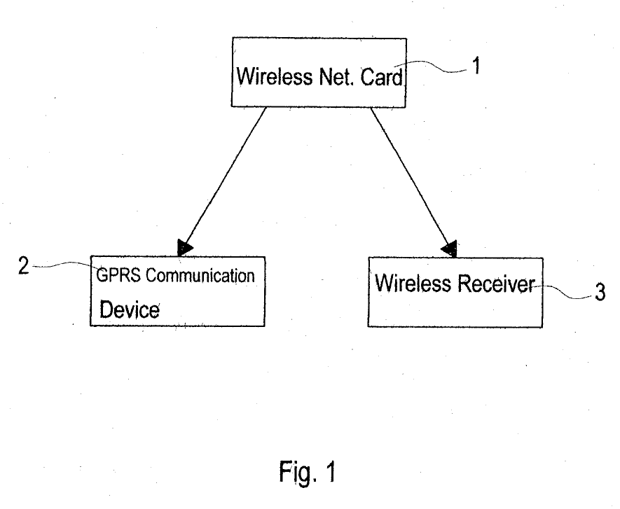

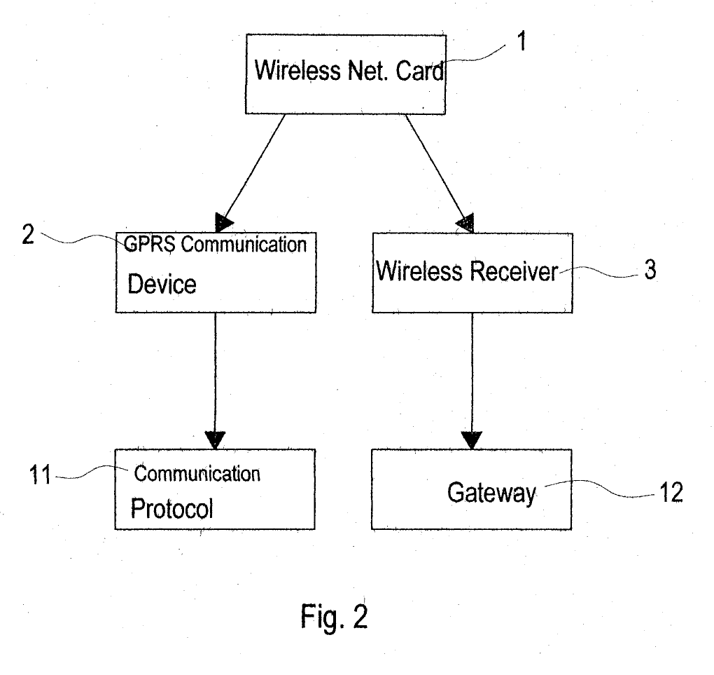

Referring to FIGS. 1 and 2, the present invention provides a dual mode wireless network card driving program. In the present invention, a dual mode wireless network card driving program is simplified. The wireless network card 1 serves to support a GPRS communication device 2 and a wireless receiver 3. The GPRS communication device 2 uses a PPP communication protocol 2 for data communication automatically so as to transmit data remotely. The wireless network card 1 includes a driving program . The wireless network card 1 is connected to a wireless receiver 3 and the wireless receiver 3 uses a gateway 12 for near-end data communication. When the GPRS communication device 2 is closed, the wireless network card 1 is switched to the wireless receiver 3 for near-end transmission. The wireless network card 1 can be switched to the GPRS communication device 2 so as to be used suburbs. When the user is indoors, the wireless network card 1 can scan the wireless receiver 3. If the wireless receiver 3 exists, then the mode is switched to the wireless receiver 3.

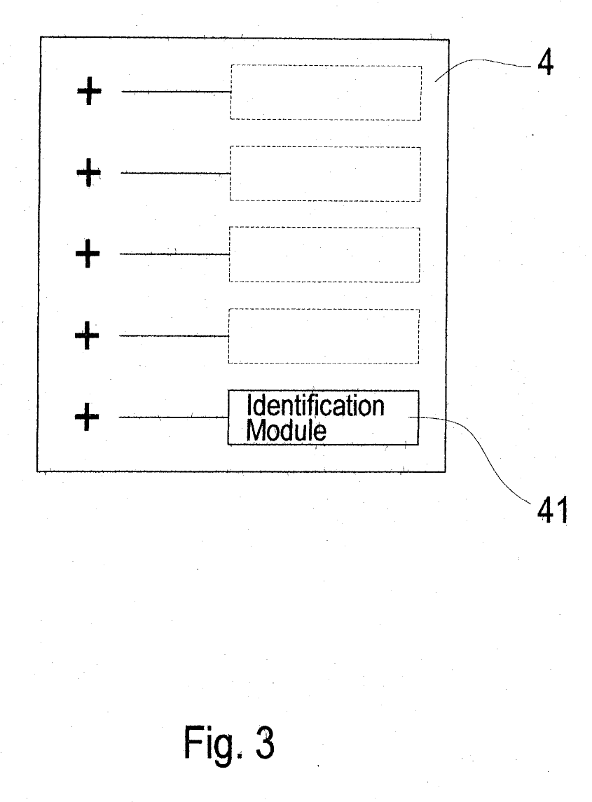

Referring to FIG. 3, it is illustrated the control end of the wireless network card 1 of the present invention has an identification module 41 which serves to identify the modes of the external devices to be a GPRS communication device 2 or a wireless receiver 3.

Advantages of the present invention is that the wireless network card can process the data from the GPRS communication device and a wireless receiver 3. The wireless network card 1 uses a driving program to switch the GPRS communication device 2 and the wireless receiver 3 so that it can be used to receive near end data or far end data. Only one driving program is used so that the operation is convenient.

In the present invention, the gateway serves to receive signals from satellites and then the signals are transmitted to the wireless network card. When the wireless network card is switched to the wireless receiver; the bandwidth for data transmission is changed.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dual mode wireless network card for supporting a GPRS communication device and a wireless receiver; wherein
the wireless network card is connected to a GPRS communication device and a wireless receiver; the GPRS communication device uses a PPP communication protocol for using in far-end data communication; the wireless receiver transmits data through a gateway for performing near-end data communication;
the wireless network card includes a driving program for switching; wherein when the GPRS communication device is turned off, the wireless network card is switched to the wireless receiver for near-end transmission; the wireless network card can be switched to the GPRS communication device so as to be used suburbs; when the user is indoors with the GPRS communication device being turned on, the wireless network card scans the wireless receiver; if there are signals of the wireless receiver, then the mode is switched for receiving signals of wireless receiver.

2. The dual mode wireless network card for supporting a GPRS communication device and a wireless receiver as claimed in claim 1, wherein the gateway serves to receive signals from satellites and then the signals are transmitted to the wireless network card.

3. The dual mode wireless network card for supporting a GPRS communication device and a wireless receiver as claimed in claim 1, wherein when the wireless network card is switched to the wireless receiver; bandwidths for data transmission is changed.
